(19) United States
(12) Patent Application Publication
(10) Pub. No.: US 2006/0118540 A1
(43) Pub. Date: Jun. 8, 2006

(54) Semiconductive members and belts

(76) Inventors: Bradley Leonard Beach, Lexington, KY (US); Donald Leo Elbert, Lexington, KY (US); Matthew Thomas Houston, Florence, KY (US); Joseph Edward Johnson, Lexington, KY (US); Kathryn Dowlen Mullins, Lexington, KY (US); Peter Brown Pickett, Lexington, KY (US); John Decker Ringo, Lexington, KY (US); Ronald Lloyd Roe, Lexington, KY (US); Jing X. Sun, Lexington, KY (US); Kevin Edward Trembath, Reno, NV (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/005,814

(22) Filed: Dec. 7, 2004

(51) Int. Cl. H05B 3/00

(52) U.S. Cl. 219/216

(57) ABSTRACT

A semiconductive member has a polymer body filled with carbon black which is surface modified with azo linked organic molecules having an acid functional group. Control of conductivity is greatly improved and the strength of the member is improved by the reduced amount of filler required.

### TECHNICAL FIELD

This invention relates to members, such as flexible belts used in electrical devices for their combined physical integrity and semiconductivity, the semiconductivity being obtained by filler in polymeric material forming the belts.

### BACKGROUND OF THE INVENTION

Color electrophotographic printers typically employ intermediate transfer members or transport members in the form of belts, which have a semi-conductive resistivity that allows the fixed transport of unfused toner within the printer. A typical conductive additive used in these members is electrically conductive carbon black.

Control of the resistivity of such belts is difficult using electrically conductive carbon blacks as filler because the slope of the percolation curve in the semi-conductive region of interest is very high. Therefore slight changes in carbon black loading and processing conditions will dramatically affect the final resistivity. This sensitivity makes it difficult to control the product within reasonable variation and often results in costly monitoring and low yields.

In U.S. Pat. No. 6,303,054 B1 to Kanetake et al. an electrically semi-conductive poly(amic acid) liquid composition is described which has excellent storage stability for 180 days. In this patent the use of an electrically conductive carbon black with volatile content of 5 to 20% is disclosed for the liquid composition with a specific carbon black loading of 10 to 40% by weight.

In Patent Abstracts of Japan 2001-324880 and 2002-148957 (Assignee: Fuji Xerox, Co., Ltd.) an electrically semi-conductive intermediate transfer member is claimed which is comprised of polyimide resin and oxidized carbon black. In Patent Abstract of Japan 2002-148951 (Assignee: Fuji Xerox, Co. Ltd.) an electrically semi-conductive intermediate transfer medium is disclosed which is comprised of a polyimide resin that contains plural types of carbon blacks, in which at least one type of the said carbon blacks is an oxidized carbon black. Further specifically the foregoing 2002-148957 states that the oxidized carbon black loading should be between 10 to 30% by weight.

U.S. Pat. No. 6,494,946 B1 (particularly Examples 45 and 46), U.S. Pat. Nos. 6,110,994 and 6,472,471 B1 disclose improved dispersions of carbon black surface modified. The U.S. Pat. No. 6,494,946 patent employs diazonium salts for surface modification, resulting in direct attachment of organic groups to carbon black.

This prior art does not indicate a decrease in the slope of the carbon black percolation curve. It is believed that the prior art establishes a minimum carbon black loading required to attain the desired semi-conductive resistivity of about 10% by weight. Also, a “typical” electrically conductive carbon black, such as CSX 579 from Cabot Corp. has a volatile content of <5% and exhibits a steep slope over the semi-conductive region of interest (1E9-1E 13 ohm cm) at a carbon black loading of 10 to 12% by weight.

### DISCLOSURE OF THE INVENTION

In an effort to solve this sensitivity to carbon black loading in accordance with this invention the surface of a nonconductive carbon black is changed by covalently bonding an organic acid compound to the carbon black surface. This makes the carbon black semiconductive and improves the dispersibility within the polymer. The final additive is a surface modified carbon black having at least one organic moiety with a carboxylic acid or other polar functional group attached to the surface of the carbon black by a covalent, azo linkage. The polar functional group may be acidic or basic, such as an amino functional group. This modified carbon black having a volatile content of greater than 25% and a loading of only 2% to 9% by weight of the filled polymer is able to achieve the desired resistivities for the semi-conductivity of a polymer film. Another advantage of the modified carbon black in a polymer is that the slope of resistivity vs. loading is not steep, thus allowing more control in obtaining optimal electrical properties.

In an embodiment the modified carbon black is milled using both solvent and final polymer to form a casting solution which is either spin cast or spray coated on the inside of a hollow drum. This drum or mandrel is heated to remove the solvent and cure the materials to form a final seamless polymer. A belt may be obtained for use as an intermediate transfer member in xerographic printing which minimizes print defects, particularly mottle and voiding.

In order to chemically modify the surface of the carbon black the diazotization of para-aminobenzoic acid is employed as described in the following reactions:

### Diazotization of Para-Aminobenzoic Acid

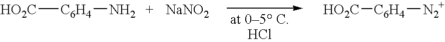

This reaction may be conducted in situ with a carbon material. The ionic nitrogen then reacts with the surface of the carbon black to form an azo linkage, thus attaching the benzoic acid group to the carbon black as a surface modification.

In use the acid functional groups may be the free acid or its salt.

### BRIEF DESCRIPTION OF THE DRAWINGS

The details of this invention will be described in connection with the accompanying drawings, in which

FIG. 1 is a chart of the result of X-ray photoelectron spectroscopy showing an N═N peak, which verifies an azo bond to the carbon black,

FIG. 2 is an exemplary cure schedule for the making of a multi-layer intermediate transfer medium belt, and

FIG. 3 is a percolation curve comparison for a belt having standard conductive carbon black and a belt having carbon black with azo attached carboxylic acid substituents in accordance with this invention.

### DESCRIPTION OF THE PREFERRED EMBODIMENTS

Embodiments of this invention may be as a semiconductive belt having a semiconductive layer, as well as other layers, such as a support layer. As such, when installed for use in an electrophotographic printer or other electrical device as an intermediate transfer member, the belt is in contact with a surface which provides an electrical potential. Such intermediate transfer members are normally endless and are rotated during use. As such they must be physically strong and stable over time. For electrophotographic operations they must have a conductivity which is correct for the operation and stable over time. Finally, such belts must be compliant to receive a full pattern of loose toner under pressure and to not bind toner during a subsequent transfer of toner onto paper, so as to permit substantially complete transfer of the toner.

This invention achieves the foregoing objectives in that conductivity is readily controlled using the surface modified carbon black of this invention. Moreover, the physical integrity of the belt is enhanced by the reduced amount of the modified carbon black used. The following describes this invention in the context of such intermediate transfer member, but should be understood as merely illustrative of application of electrically conductive polymers of this invention.

An example structure of an intermediate transfer member would contain a surface layer which exhibits excellent acceptance and release of toner, a compliant layer which allows the structure to adapt to rough paper surfaces, and a tensile layer which gives stability and strength to the structure.

Surface Layer:

Specific vendors specialize in formulation of release layers for use of materials used in electrophotograpic printers. This may be a low temperature cure blend of polytetrafluoroethylene (PTFE) and perfluoroalkoxy polymer (PFA). This layer is specifically designed to accept and release toner with exceptional quality using electrostatic fields and minimal mechanical force. A layer of about 5 to 10 microns is adequate to achieve the desired properties.

Intermediate Compliant Layer:

To form a semi-conductive silicone compliant layer a mixture of conductive and non-conductive two part silicones are formulated in the appropriate ratio. To achieve a low tack surface a surface treated fumed silica is added into the formulation, as follows:
To a 1 L beaker add 289.86 g xylene, 137.2 g two component conductive silicone (Shincor, KE1378A/B), 26.66 g two component non-conductive silicone (Shincor, X-34-1191 A/B), and 13.91 g fumed Silica (Cabot, Cab-o-sil TS-720). Mix thoroughly for 30 minutes using an air stirrer.

A layer of 150 to 500 microns is adequate to achieve the surface compliancy needed for excellent print quality.

Base Tensile Layer:

To improve the dispersibility of carbon black within the final polyamideimide matrix of the base tensile layer, the surface of the carbon black is chemically changed in accordance with this invention such that the final carbon black surface contains diazo-coupled, carboxylic acid functionalized phenyl groups. The surface modified carbon black is then milled in an attritor using an appropriate solvent and a polymer to produce a stable dispersion.
Add 500 g of deionized water to a l-L beaker, equipped with mechanical stirring, thermometer, and place in an ice bath. Begin stirring and add 69.0 g of para-aminobenzoic acid. Then slowly add 140.0 g of 12 molar (M) hydrochloric acid (HCl 37% reagent grade). Decrease the solution temperature to less than 5° C. by adding ice to the solution. Add 36.0 g of sodium nitrite to the solution and let stir for 30 minutes. Remove excess nitrite using approximately 1 g of sulfamic acid.

Surface modification of carbon black follows using azo-coupling as described in the following reaction and example procedure:

### Azo-Coupling of Phenyl Acid to Carbon Black

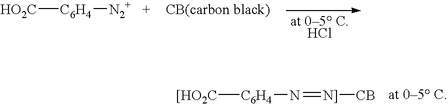 To the solution prepared above add 60.0 g of MONARCH 880® carbon black while continuing to stir and keeping temperature conditions at less than 5° C. for a period of 3 hours. After that time, very slowly raise the pH of the slurry to 5.5 using 6.0 M of sodium hydroxide (NaOH). Maintain the pH at 5.5 for several hours, preferably overnight. Then slowly raise the pH of the slurry to 7.5 using 6.0 M of sodium hydroxide. Shortly thereafter add 12 M HCl to the slurry decreasing the pH to 2, thus fully acidifying the carboxyl groups, causing the modified carbon black to precipitate. Filter the slurry to isolate the surface-treated carbon black. Rinse the product with deionized water to remove any excess ionic contaminants. The surface-treated carbon black is then dried in an oven. The procedure yields about 100 g of surface modified carbon black. To verify the presence of the azo linkage on the carbon black surface, X-ray photoelectron spectroscopy was performed for the surface treated carbon black.

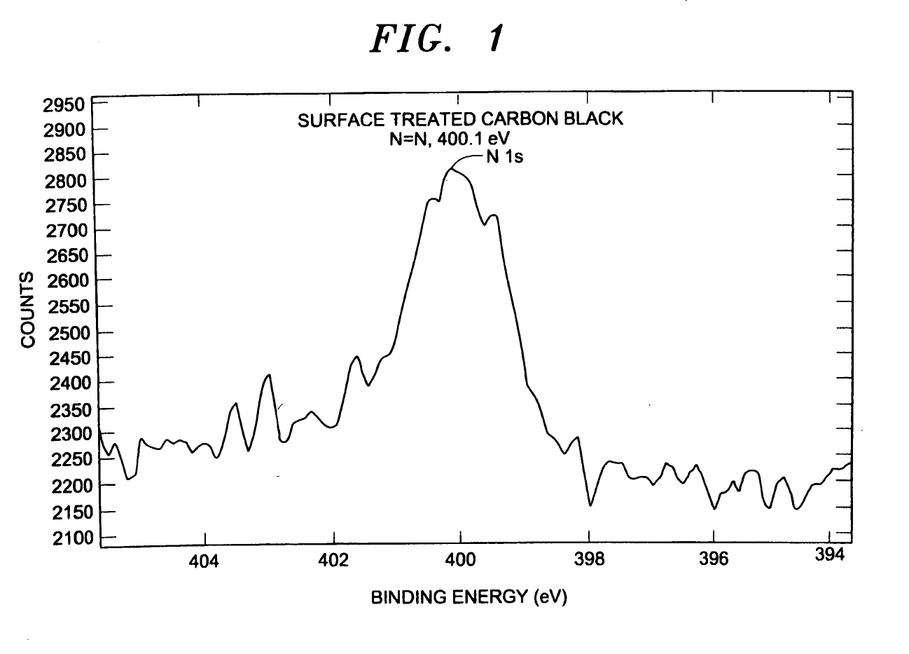

At 400.1 eV the N═N bond is very apparent (see FIG. 1). The starting carbon black shows no such bond.

Once the surface modified carbon black has been isolated and dried, a stable dispersion of the modified carbon black in polymer and solvent is prepared using the following procedure:
First prepare a polymer premix solution by adding 177.03 g n-methyl-2-pyrrolidone (NM2P) and 58.9 g xylene to a 600 mL beaker equipped with a mechanical stirrer. Begin stirring and add 0.32 g ZONYL® FSN100 (Dupont) surfactant. Add 78.75 g TORLON® AI-10 polyamideimide powders (Solvay Advanced Polymers) and continue stirring until completely dissolved. To a ball mill cup, add the following: 300.0 g of polymer premix solution, 19.7 g of surface modified carbon black, and 1200 g of 1.25 mm YTZ (yttrium, tantalum, zirconium) shot. Mill at 100 RPM for 10 minutes using a ball mill attritor. Then mill at 400 RPM for 12 to 14 hours. Isolate this concentrate mixture from the YTZ shot. Prepare the final casting solution by adding the following into a 300 mL beaker with stirring: 20.0 g concentrate mixture solution prepared above and 38.3 g polymer premix solution. This amount of casting solution contains: 32.1 g NM2P, 10.7 g xylene, 0.01 g FSN100 surfactant, 15.5 g TORLON® powder, and 1.23 g surface modified carbon black.

A layer of 10 to 30 microns is adequate to achieve the desired tensile and electrical stabilization properties.

Seamless Belt Preparation:

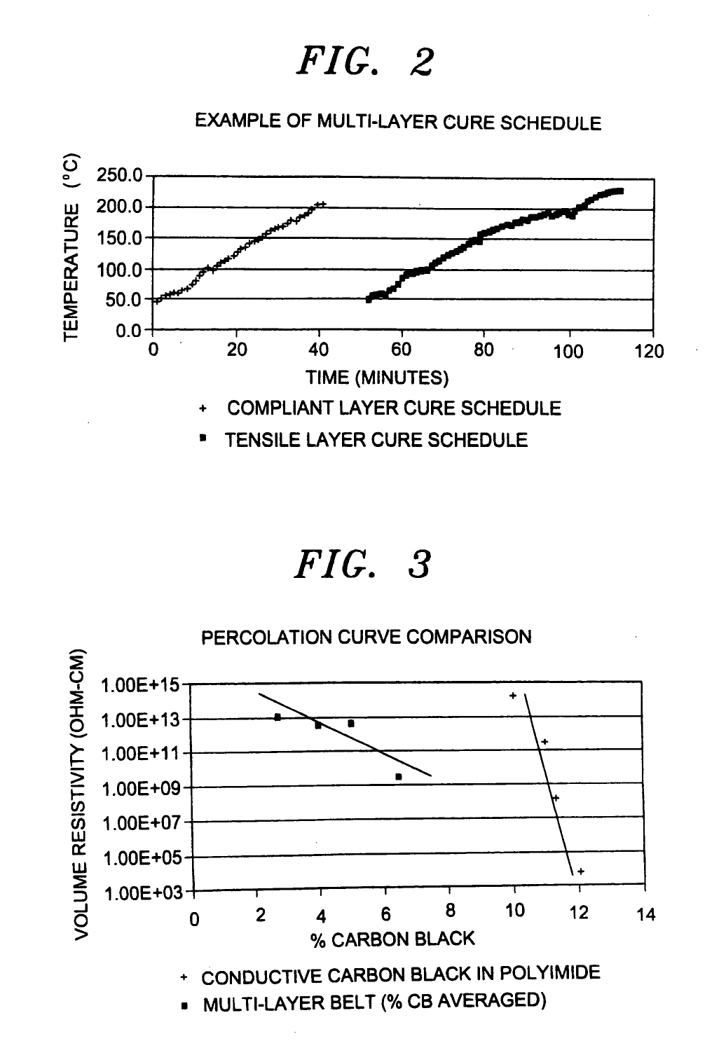

The solutions prepared for each layer can be applied sequentially to form the final seamless member using a centrifugal casting device. The centrifugal casting device has a precision machined cylinder rotating concentrically at constant high speeds (˜2,000 RPM). The surface layer solution is added to the rotating cylinder such that the solution spreads out uniformly inside the cylinder. The solution is then dried to a solid film by applying direct IR radiation from quartz IR heating elements. Also, airflow is forced through the cylinder to aid in the drying process. Each layer is processed and added sequentially without stopping the rotating cylinder and each layer has a separate cure schedule designed for each material. A cure schedule example for a 2-layer belt system is shown in FIG. 2. The temperatures can be measured at the film surface by IR thermocouples. The cylinder and film are then cooled, the rotation stopped, and the final seamless member is removed with the use of a TEFLON® or DELRIN® spatula. Alternately the tensile layer and compliant base layer can be formed by using the centrifugal casting device, and the surface layer applied separately to the compliant layer by spray or dip coating, followed by an oven cure cycle.

### Belt Properties

Resistivity Comparison:

Comparative results of percolation curves using a typical conductive carbon black (CSX 579 from Cabot) in a polyimide system and the herein described multi-layer belt systems are attached in FIG. 3. Note that the CSX 579 carbon black is not surface-treated. The slope of the percolation curve is dramatically decreased using the surface modified carbon black in the multi-layer belt systems. Another benefit of the surface modified carbon black is that the semi-conductive region of interest (1E9 to 1E13) is achieved with a significantly lower carbon black loading. It is well known that the flex fatigue of most polymer films will degrade as the carbon black loading is increased, so in order to maximize the polymer mechanical properties for this application it is advantageous to minimize the carbon black loading.

Print Quality Comparison:

Using the based platform of the LEXMARK C750 color laser printer for testing a typical single layer belt will exhibit extreme mottle on rough papers such that an even color of “red,” “blue,” or “green” (two layers of toner printed in a solid block) is not able to be achieved. When using the belt systems corresponding to the foregoing imaging is excellent. Even blocks of “red” are achieved whereby no mottling was observed over several typical rough media.

The foregoing has the most rigid layer, the tensile layer, on the bottom. Alternatively, that layer can be the middle layer, with the compliant layer on the bottom. In any event, in use in an electric apparatus, the bottom layer contacts a source to provide electrical potential to the intermediate transfer layer.

In addition to the aforementioned characteristics, the intermediate transfer member has shown to produce superior print quality when the surface of said member is compliant, i.e. it is able to be deformed easily with minimal pressure, thus ensuring improved physical interactions to final media resulting in uniform toner transfer.

One key print quality property is mottle, characterized as non-uniformity in the appearance of the toner on the final media. Mottle is caused by the lack of complete transfer of the toner from the transfer belt to the media. Mottle on the final printed output is dramatically improved when the surface of the intermediate transfer member is compliant, in large part due to the improved physical interactions between the transfer belt and the media surface.

During the operation of transferring toner to the final media, of which may have significant texture, areas exist in which the toner does not have any mechanical contact with the media. In these regions, there is no mechanical force applied to the toner from the final media, only electrostatic force due to the presence of an electric field during transfer. Due to high mechanical adhesion of the toner to a typical intermediate transfer member (ITM), the toner does not completely transfer from the ITM to the final media. Having a compliant surface on the proposed ITM embodiment allows the toner to be conformed to the low regions of the final media without a significant increase in the applied transfer force. With the belt and toner having been placed in complete mechanical contact in all regions of the media, both electrostatic and mechanical forces contribute to bringing the toner from the ITM to the media resulting in a uniform manner, which reduces or eliminates mottle.

An additional print quality attribute significantly affected by the use of a compliant ITM is voiding. Voiding is characterized by small, completely missing areas of toner in small features such as ‘serifs’ on text or small vertical lines (for example lower case “L”) on the final media. Hollow defect characters are the result of the voiding print quality defect. This defect is theorized to be caused by very large localized pressure regions between the photoconductor (“image bearing member”) and the ITM (“image receiving member”) or the ITM (“image bearing member” in this case) and the final media (“image receiving member”). When a small, isolated portion of toner is brought in contact with the image receiving member by the image bearing member, the typical image receiving member has enough stiffness to be raised and removed from the image bearing member by the quantity of toner in the small image. The image-receiving member loses contact over a significant width as compared to the width of the toner image. As a result, a portion of the total force that formerly was distributed across the entire width of the image-bearing member is now focused solely on the small amount of toner in the image. This localized high pressure causes the toner particles to mechanically adhere to each other and the aggregated material does not transfer completely to the image receiving member. This occurs at random and causes complete holes in small features as described earlier. With the addition of the compliant surface to an ITM, the localized pressure is alleviated. No further voiding or hollow characters result.

Voiding is also influenced by the mechanical adhesion of the toner to the ITM surface. Thus, another requirement of the intermediate transfer member would be to have a surface, which easily accepts and releases toner by the use of electrostatic fields, such as by using specific fluoropolymers. Reducing the mechanical adhesion between the ITM and the toner is key to being able to use the present electrostatic and mechanical forces to completely transfer toner to and from the ITM surface.

Various alternatives will be apparent so long as the filler is an azo connected organic acid as described.

What is claimed is:

1. A belt in an electrical device, the surface of said belt being in contact with a source of electrical potential, said belt comprising a polymeric body filled with carbon black which is surface modified by having on its surface by azo linkage to at least one organic moiety having a polar functional group.

2. The belt as in claim 1 in which the functional group is a carboxylic acid functional group.

3. The belt as in claim 2 in which said surface modified carbon black is about 2 to about 9 percent by weight of the total weight of said polymer body.

4. The belt as in claim 1 in which said belt is an endless intermediate transfer member in an electrophotographic imaging device.

5. The belt as in claim 2 in which said belt is an endless intermediate transfer member in an electrophotographic imaging device.

6. The belt as in claim 3 in which said belt is an endless intermediate transfer member in an electrophotographic imaging device.

7. The intermediate transfer member as in claim 4 comprising a release layer, a compliant layer, and a tensile layer, and in which said tensile layer is said filled polymeric body.

8. The intermediate transfer member as in claim 5 comprising a release layer, a compliant layer and a tensile layer, and in which said tensile layer is said filled polymeric body.

9. The intermediate transfer member as in claim 6 comprising a release layer, a compliant layer and a tensile layer, and in which said tensile layer is said filled polymeric body.

10. The belt as in claim 2 in which said organic moiety having said functional group is benzoic acid.

11. The belt as in claim 3 in which said organic moiety having said functional group is benzoic acid.

12. The belt as in claim 5 in which said organic moiety having said functional group is benzoic acid.

13. The belt as in claim 6 in which said organic moiety having said functional group is benzoic acid.

14. The intermediate transfer medium of claim 8 in which said organic moiety having said functional group is benzoic acid.

15. The intermediate transfer medium of claim 9 in which said organic moiety having said functional group is benzoic acid.

16. A semiconductive member comprising a polymeric body filled with between 2 to 9 percent by weight of the total weight of said filled polymeric body of carbon black which is surface modified by having on its surface by azo linkage at least one organic moiety having a carboxylic acid functional group.

17. The semiconductive member of claim 16 in which said member comprises said filled polymeric body in a layer.

18. The semiconductive member of claim 17 in which said member is an endless belt.

19. The semiconductive member of claim 16 in which said organic moiety having said functional group is benzoic acid.

20. The member of claim 17 in which said organic moiety having said functional group is benzoic acid.

21. The belt as in claim 18 in which said organic moiety having said functional group is benzoic acid.
